(19) United States
(12) Patent Application Publication
(10) Pub. No.: US 2023/0012683 A1
(43) Pub. Date: Jan. 19, 2023

(54) Universal Media Cable Harness

(71) Applicant: Charles Cevallos, San Antonio, TX (US)

(72) Inventor: Charles Cevallos, San Antonio, TX (US)

(21) Appl. No.: 17/865,678

(22) Filed: Jul. 15, 2022

Related U.S. Application Data
(60) Provisional application No. 63/222,223, filed on Jul. 15, 2021.

(51) Int. Cl. H01B 7/00; H01R 13/46

(52) U.S. Cl. CPC H01B 7/0045; H01R 13/465

(57) ABSTRACT

A cable harness that holds multiple types of media cables into a single unit for connecting components to a device without having to access the device's input panel. The cable harness has a sleeve that keeps all the cables organized and held together. Each of the cables have two ends, a male end and a female end. One end of the harness has male ends of the cable that connect to the input panel of a device while the other end has the female ends of the cable to make switching out components possible without having to access the device's rear input panel. The cable harness has a plurality of cables including a HDMI cable, a USB cable, an Ethernet cable, and an Optical cable. The cables are slidably harnessed together allowing the sleeve to be close to one end of the cable if need be. The sleeve allows cables to move independently for easier and faster connections. The cables have a labeling so that the same cable has the same label on each end of the cable so the user knows which end of one of the cables corresponds to the correct other end of the cable.

The current application claims a priority to the U.S. Provisional Patent application Ser. No. 63/222,223 filed on Jul. 15, 2021.

### FIELD OF THE INVENTION

The present invention relates generally to wiring for electronics. More specifically, the present invention is a combination of multiple types of media cables held together by a sleeve.

### BACKGROUND OF THE INVENTION

Cables are needed to transfer media to a viewer's device. The media data transferred by media cables include movies, music, images, internet and more. With multiple types of media, different cables are needed to transfer the data. For example, optical cables can transfer audio data while ethernet cables can transfer internet data. In order to display content through various sources to a viewing device, multiple types of media cables are needed to run a single device such as a TV. A TV can require visual cables, audio cables, and sometimes an Ethernet cable if the TV is a smart device capable of being connected to the internet. People are required to buy multiple sets of cables to wire their desired device set up. People are also burdened with having to access the back of the TV where the main media ports are located. When a person wants to remove or add a device to the TV, they must access the main ports located on the back of the TV. This can be a hassle depending on the set up of the TV. Overall, the wiring process for TVs and other media devices can be complex. Additionally, there may be limited space between the wall and the device making it difficult to access the cable ports.

An objective of the present invention is to simplify the cable wiring process of media devices. The present invention combines multiple types of media cables into one assembly. The present invention provides easy access to all cables needed for general media data transfer, by extending the main media ports from behind the TV or media device. The types of media cables included are HDMI, Optical, USB, and Ethernet. These types of media cables are generally required to operate most media devices. However, additional types of media cables can be integrated to accommodate new types of media transfer technologies. The present invention creates an easier process for people who need to wire their media devices.

### SUMMARY OF THE INVENTION

The present invention combines multiple types of media cables into a single cable harness assembly. The present invention includes HDMI, USB, Ethernet, and Optical cables. Each media cable included comprises a male end and a female end. Each end is labeled for identification purposes to ensure that the proper connections are made. The media cables are bound together by a sleeve. The media cables can slide within the sleeve which creates more flexibility for the ends of the media wires. Each embodiment of the present invention includes at least one HDMI cable, at least one USB cable, at least one Ethernet cable, and at least one Optical cable. In some embodiments of the present invention, more than one type of cable can be added to increase the capability of the present invention.

### BRIEF DESCRIPTION OF THE DRAWINGS

FIG. 1 is a top perspective view of the preferred embodiment of the present invention, wherein the present invention includes three HDMI cables, two USB cables, one Optical cable, and one Ethernet cable.

FIG. 2 is a top view of the preferred embodiment of the present invention.

FIG. 3 is a side view of the preferred embodiment of the present invention.

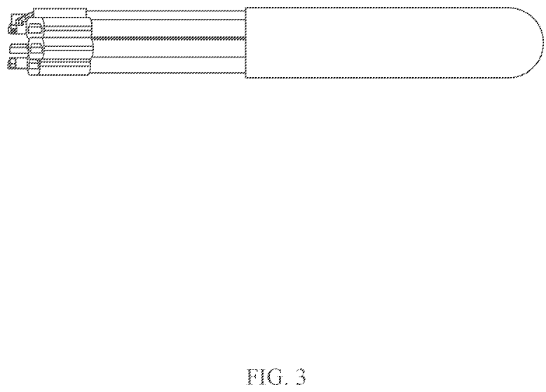

FIG. 4 is a top perspective view of another embodiment of the present invention, wherein the present invention includes one HDMI cable, one USB, one Ethernet cable, and one optical cable.

### DETAIL DESCRIPTIONS OF THE INVENTION

All illustrations of the drawings are for the purpose of describing selected versions of the present invention and are not intended to limit the scope of the present invention.

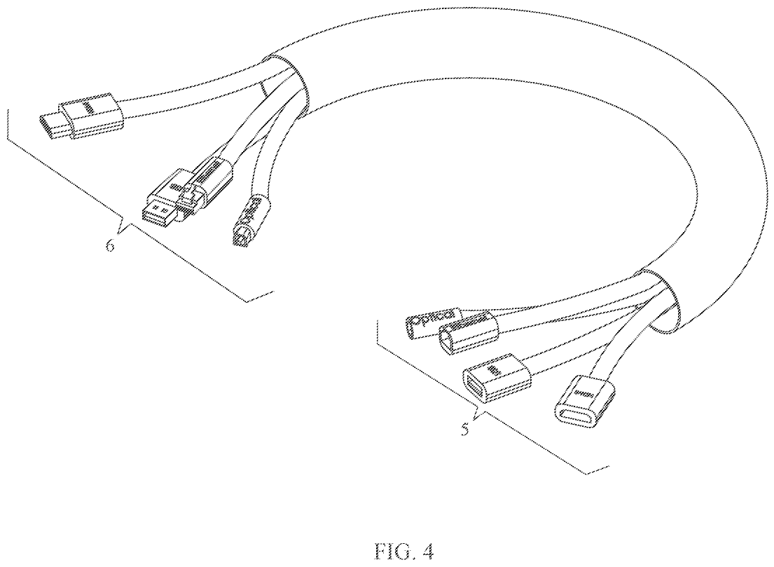

The present invention is a combination of different media cables integrated into a single structure. The present invention is a cable harness 1 and comprises a sleeve 2 with a plurality of cables which includes: the at least one High Definition Multimedia Interface cable (HDMI), the at least one Universal Serial Bus cable (USB), the at least one Optical cable, and the at least one Ethernet cable. In another embodiment the plurality of cables comprises a plurality of HDMI cables 11, a plurality of USB cables 12, a plurality of optical cables 13, and a plurality of Ethernet cables 14. Each of the plurality of cables in the present invention comprises two ends. The two ends comprise a female end 5 and a male end 6. For example, the HDMI cable comprises one male end and one female end, the USB cable comprises one male end and one female end, etc. As seen in FIG. 4, all male ends are preferably located on one side of the present invention and all female ends are located on the opposite side of the present invention. Each of the plurality of cables in the present invention is preferably the same length. This means that the at least one HDMI cable is the same length as the at least one USB cable, the at least one Ethernet cable, and the at least one Optical cable. Each of the plurality of cables also comprises a label 3 that helps users identify which male end is connecting to the corresponding female end in the present invention. Furthermore, this is also done to ensure they are inserted correctly into the device and the port. For example, the male end of the at least one HDMI cable can be labeled 3 “HDMI 1” while the female end of the at least one HDMI can also be labeled 3 “HDMI 1.” This will indicate that both ends labeled 3 “HDMI 1” are connected through the same wiring bound by the sleeve. The labels 3 help users connect the correct male end to the correct female end of their media devices.

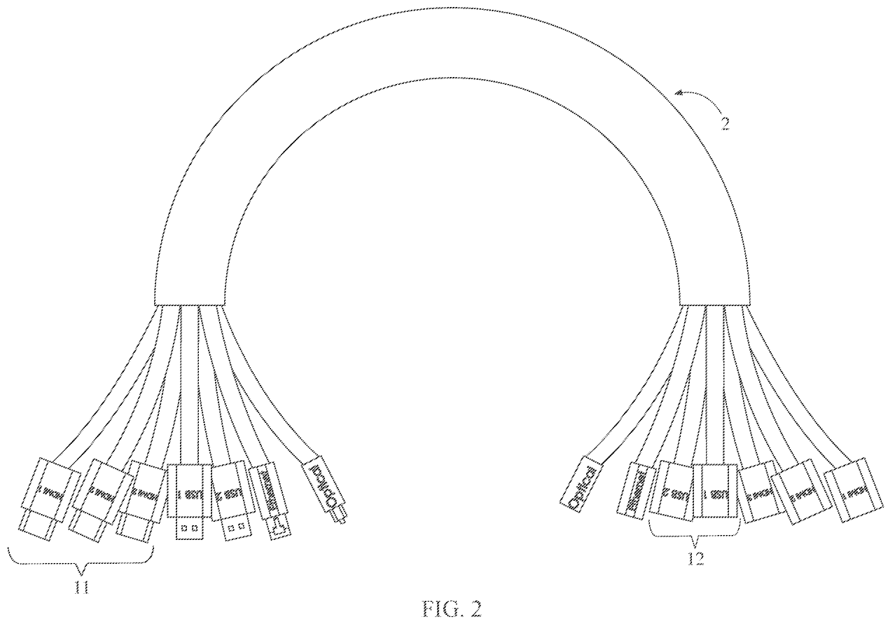

As shown in FIG. 2, the present invention comprises a sleeve that neatly holds the plurality of cables including the at least one HDMI, the at least one USB, the at least one Ethernet, and the at least one Optical cable. The sleeve is a thin flexible tubular structure that can slide along the exterior of the plurality of cables. The sleeve is long enough to keep the plurality of cables oriented in the same direction but short enough to leave space for plurality of cables to separate at the ends. This allows users to separate the plurality of cables without the plurality of cables leaving the sleeve. Users can easily slide the plurality of cables without damaging or stretching the sleeve. In the preferred embodiment of the present invention, the spacing between the end of the sleeve and the ends of the plurality of cables is ten inches. In other embodiments of the present invention, the spacing between the end of the cables and the end of the sleeves can be longer or smaller. In addition, the sleeve can be made of insulating materials with high flexibility. This includes, but is not limited to, rubber, heat shrink, or highly flexible plastic materials.

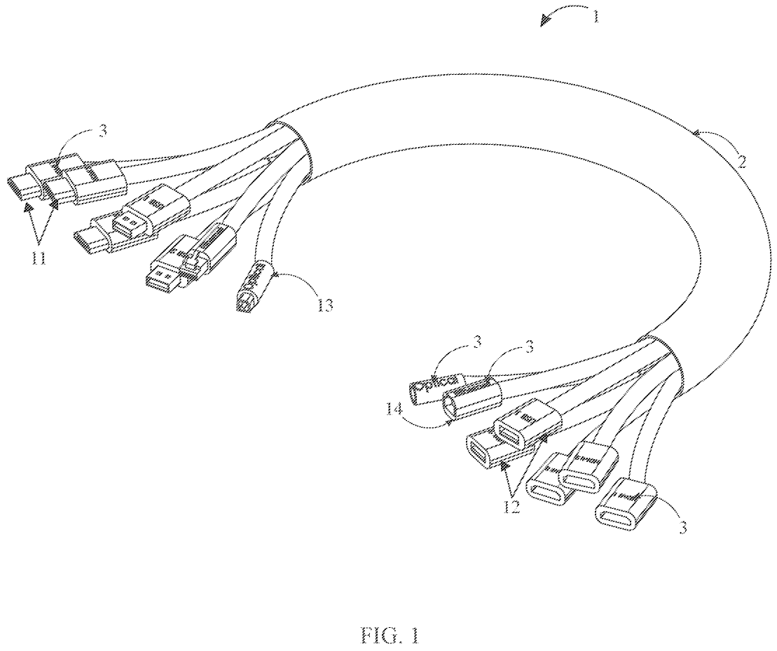

As shown in FIG. 1, the preferred embodiment of the present invention comprises three HDMI cables, two USB cables, one Optical cable, and one Ethernet cable. This is the fullest embodiment of the present invention and provides users more options when selecting from the plurality of cables. In other embodiments of the present invention, the quantity of one type of cable can vary. For example, the present invention can comprise two HDMI cables, two USB cables, one Optical cable, and one Ethernet cable or the present invention can comprise four HDMI cables, three USB cables, one Optical cable, and one Ethernet cable. The length of the present invention can vary. For example, the present invention can be three feet in length or ten feet in length.

Although the invention has been explained in relation to its preferred embodiment, it is to be understood that many other possible modifications and variations can be made without departing from the spirit and scope of the invention.

What is claimed is:

1. A cable harness comprising:
a sleeve, wherein the sleeve is a flexible tube;
wherein the sleeve is slidably connected to the exterior of the cables;
a plurality of HDMI cables;
a plurality of USB cables; and
a plurality of optical cables.

2. The cable harness as in claim 1 further comprising:
each of the plurality of HDMI cables comprising two ends;
the two ends comprising a male end and a female end; and
the two ends of each of the plurality HDMI cable being labeled.

3. The cable harness as in claim 1 further comprising:
each of the plurality of USB cables comprising two ends;
the two ends comprising a male end and a female end; and
the two ends of each of the plurality USB cable being labeled.

4. The cable harness as in claim 1 further comprising:
each of the plurality of optical cables comprising two ends;
the two ends comprising a male end and a female end; and
the two ends of each of the each of the plurality of optical cables being labeled.

5. The cable harness as in claim 1 further comprising:
a plurality of ethernet cables;
each of the plurality of ethernet cables comprising two ends;
the two ends comprising a male end and a female end; and
the two ends of each of the plurality of ethernet cable being labeled.

6. A cable harness comprising:
a sleeve, wherein the sleeve is a flexible tube;
wherein the sleeve is slidably connected to the exterior of the cable;
at least one HDMI cable;
at least one USB cable;
at least one optical cable;
the at least one HDMI cable comprising two ends;
the two ends of the at least one HDMI comprising a male end and a female end;
the two ends of the at least one HDMI cable being labeled.
the at least one USB cable comprising two ends;
the two ends of the at least one USB comprising a male end and a female end; and
the two ends of the at least one USB cable being labeled.

7. The cable harness as in claim 6 further comprising:
at least one ethernet cable;
the at least one optical cable comprising two ends;
the two ends of the at least one optical cable comprising a male end and a female end;
the two ends of the at least one optical cable being labeled.
the at least one ethernet cable comprising two ends;
the two ends of the at least one ethernet cable comprising a male end and a female end; and
the two ends of the at least one ethernet cable being labeled.
